(19) United States
(12) Patent Application Publication
(10) Pub. No.: US 2025/0387747 A1
(43) Pub. Date: Dec. 25, 2025

(54) CARBON CAPTURE FOR GAS TURBINES

(71) Applicant: CAPSOL TECHNOLOGIES ASA, Oslo (NO)

(72) Inventor: Stellan HAMRIN, Kungsör (SE)

(21) Appl. No.: 19/109,008

(22) PCT Filed: Sep. 5, 2023
(86) PCT No.: PCT/NO2023/060044

§ 371 Date: Mar. 5, 2025

(30) Foreign Application Priority Data
Sep. 6, 2022 (NO) 20220959

(51) Int. Cl. B01D 53/14; B01D 53/34; B01D 53/62; B01D 53/78; B01D 53/96

(52) U.S. Cl. CPC B01D 53/1475; B01D 53/1425; B01D 53/1493; B01D 53/343; B01D 53/62; B01D 53/78; B01D 53/96; B01D 2251/306; B01D 2251/606; B01D 2257/504; B01D 2258/0291

(57) ABSTRACT

The invention relates to a method for capturing CO2 from a CO2 rich gas, the lean exhaust gas is reheated in heat exchangers and expanded over an expander to give power for driving the compressors, and a part of the heat from the cooling of the incoming CO2 rich gas in the heat exchangers is used for generating steam for regeneration of the rich absorbent, where the CO2 rich gas is received at near atmospheric pressure and at a temperature of 350 to 900° C., the incoming exhaust gas is cooled in exhaust gas heat exchangers and compressed in compressors before introduced into the absorber.

### FIELD OF INVENTION

The present invention relates to a method and plant for CO₂ capture from a CO₂ containing exhaust gas, such as exhaust gas from an industrial process or from combustion of carbonaceous fuel.

### BACKGROUND

The latest decades the environmental awareness, and especially the awareness of the effect of emission of “greenhouse gases”, i.e., gases being responsible for increasing the atmospheric temperature, has increased. This increase in awareness has resulted in the development of United Nation's Sustainable Development Goals, which has been adopted by numerous countries, and which has resulted specific targets for i.a. emission of greenhouse gases, such as CO₂, to reduce the emission of CO₂ substantially with a few years. However, the world's nations are presently highly dependent on fossil fuels, and transition to other sources for energy takes more time than the time needed to develop and build no or low emission sources for power.

Accordingly, an important strategy to reduce the emission of CO₂, is CO₂ capture and storage, where CO₂ is captured from larger or smaller CO₂ emitting activities and stored in stable geological structures.

Many concepts and projects for CO₂ capture have been suggested, but few of them have developed from idea or drawing to actual projects, due to both high investment and running cost of such plants, and the lack of political support.

Most of the proposed projects for CO₂ capture are based on post combustion CO₂ capture, where CO₂ containing exhaust gas is introduced into an absorber, where the CO₂ containing gas is brough in intimate contact with a CO₂ absorbent to remove or at least substantially reduce the CO₂ content of the exhaust gas before it is released into the surroundings. The absorbent having absorbed CO₂ is then introduced into a regenerator to regenerate the absorbent for re-use, and the captured CO₂ is removed for deposition/storage.

The most commonly used absorbents are inorganic absorbents, normally aqueous solutions of potassium carbonate, and organic absorbents, normally aqueous solutions of one or more organic amines or amino acids. Organic absorbents are prone to degradation during use, especially in presence of oxygen. Some of the degradation products of amines known from operation of such plants are known as toxic and carcinogenic compounds and may be released into the surroundings together with the CO₂ depleted exhaust gas. Operation of a capture plant using organic absorbents at a higher pressure than atmospheric pressure increases the problem of degradation as the partial pressure of oxygen is increased by compression. Potassium carbonate, on the other hand, is relatively inexpensive, is chemically stable in the operating conditions of the capture plant and produces no toxic or carcinogenic degradation products.

The speed of reaction and system equilibria for capture of CO₂ in a capture plant is highly dependent on the partial pressure of CO₂ in the absorber, i.e., the part of the capture plant where the CO₂ containing gas is brought in intimate contact with the absorbent. Additionally, using high pressure reduces the gas volume, and makes it possible to reduce the size of the plant significantly, and thus reducing the construction cost.

WO 0048709, to Norsk Hydro, relates to a method for capturing CO₂ from an exhaust gas from a primary power plant, such as a gas turbine-based power plant. Expanded and cooled exhaust gas from the gas turbine power plant is re-compressed to a pressure of 5 to 30 bar, typically 7 to 20 bar, and cooled before the compressed gas is introduced into an absorber and brought in contact with an amine absorbent in an absorber of a CO₂ capture plant. The CO₂ depleted exhaust gas is reheated against the incoming exhaust gas before expansion of the gas over an expander to give power for compression of the incoming exhaust gas. A drawback of this approach is that it requires integration between a gas turbine of the primary power plant to run a secondary power system, which limits the potential use of the method and plant to gas turbine plants. Additionally, the method requires integration with a heat recovery steam generator (HRSG) or the gas turbine plant. Another drawback of the method described therein, is the use of an aqueous amine solution as absorbent. Amines used in CO₂ absorbents are prone to degradation by oxygen present in exhaust gases at the temperatures in the absorber wherein the exhaust gas is brought into intimate contact with the absorbent. The degree of degradation is both dependent on the amine in question, the temperature, and the oxygen partial pressure. Some of the amines used, or the degradation products thereof, are known or suspected to be poisonous or even carcinogenic.

An alternative absorbent is an aqueous solution of potassium carbonate. Use of an aqueous solution of potassium carbonate as CO₂ absorbent has been known for decades, see e.g., U.S. Pat. No. 7,328,581, EP 2300129, and EP 2643559, originally filed by Sargas AS, now assigned to CO2 Capsol, and EP 3359281 to Capsol-Eop AS, and citations referred to therein.

The present invention is directed to improvements in CO₂ capture using an aqueous solution of potassium carbonate as absorbent, allowing capture of CO₂ from a CO₂ containing gas from any source without the need for integration with the source of the CO₂ containing gas.

### SUMMARY OF THE INVENTION

According to a first aspect, the present invention relates to a method for capturing CO₂ from a CO₂ rich gas, the CO₂ is absorbed from the CO₂ rich gas to give a CO₂ lean gas and CO₂ rich absorbent, the CO₂ rich absorbent is withdrawn and introduced into a regenerator where absorbent is stripped to give a regenerated, or lean, absorbent which is recycled to the absorber, and CO₂, which is treated further, the lean exhaust gas is reheated in the heat exchangers and expanded over an expander to give power for driving the compressors, and a part of the heat from the cooling of the incoming CO₂ rich gas in the heat exchangers is used for generating steam for regeneration of the rich absorbent, where the CO₂ rich gas is received at near atmospheric pressure and at a temperature of 350 to 900° C., the incoming exhaust gas is cooled in exhaust gas heat exchangers and compressed in compressors before introduced into the absorber.

The temperatures of the incoming exhaust gas correspond to the typical temperatures from a single cycle gas turbine power plant. At a temperature of the incoming exhaust gas of approximately 350° C., the energy of the expander for expanding of the lean exhaust gas corresponds to the energy needed to compress the incoming exhaust gas in the exhaust gas compressors. At higher temperatures, energy resulting from the expansion exceeds energy used for compression, whereupon the excess energy can be used to generate electrical power by means of an electromechanical generator in order to give electrical power to different consumers in the plant or for export. However, there are practical upper temperature limits for avoiding the need for using extremely expensive materials for the heat exchangers, a cost that would make the plant far to expensive.

In an embodiment, the temperature of the incoming exhaust gas may be increased, by duct burning 70, before entering the heat exchangers 2, heating the lean exhaust gas against incoming exhaust gas.

In an embodiment, the lean exhaust gas expanded over expander 9 is entering a heat exchanger 71. In an embodiment, the lean exhaust gas is heating the incoming exhaust gas in heat exchanger 71.

According to a second aspect, the present invention relates to a plant for capturing CO₂ from an incoming CO₂ rich gas, the plant comprising an incoming exhaust gas pipe for receiving incoming exhaust gas, one or more exhaust gas heat exchanger(s) for cooling of the incoming exhaust gas, one or more compressor(s) for compression of the cooled exhaust gas, an absorber for absorption of CO₂ from the incoming exhaust gas against an aqueous potassium carbonate absorbent, a lean exhaust gas pipe for introduction of the lean exhaust gas into the exhaust gas heat exchangers for heating of the lean exhaust gas against incoming exhaust gas, an expander for expanding the lean exhaust gas before releasing the lean exhaust gas into the atmosphere, the expander is arranged to drive the compressor(s), a rich absorbent pipe for withdrawing the rich absorbent from the absorbent and introducing the rich absorbent into a regenerator for regenerating the absorbent to give lean absorbent, and lean absorbent pipe for returning regenerated, or lean, absorbent into the absorber, a steam generator is connected to one of the exhaust gas heat exchangers or a heat coil via a steam pipe and a cooling water return pipe to generate steam, and where a reboiler steam pipe is arranged to deliver the generated steam into a reboiler for heating lean absorbent to generate steam for regeneration of the absorbent in the regenerator, and a condensate return pipe for returning water condensed during heating of the lean absorbent in the reboiler back to the steam generator, where the heat exchanger(s) for cooling of the incoming exhaust gas are arranged upstream the one or more compressor(s) for compression of the cooled exhaust gas.

### SHORT DESCRIPTION OF THE FIGURES

FIG. 1 is a principle sketch of a first embodiment of a plant according to the present invention, and

FIG. 2 is a principle sketch of a second embodiment according to the present invention.

FIG. 3 is a principle sketch comprising further embodiment (70, 71) according to the present invention.

### REFERENCE LIST

1. exhaust gas pipe
2. exhaust gas heat exchanger(s), 2,
2′, 2″,2′″
3. cooled exhaust gaspipe
4. exhaust gas cooler
5. compressor(s) 5, 5′, 5″
6. intercoolers 6, 6′
7. common shaft
8. motor / expander
9. lean exhaust gas expander
10. cooled lean exhaust gas pipe
11. Outgoing exhaust gas pipe
12. steam generator, 12′ steam pipe,
12′ cooling water return pipe
13. reboiler steam pipe
14. condensate return pipe
15. reboiler
16. condensate return pump
17. compressed exhaust gas pipe
18.
19.
20. absorber
21. absorber packing 21, 21′, 21″
22. Lean absorbent pipe
23. rich absorent pipe
24. rich absorbent pump
25. rich flash tank
26. lean exhasut gas pipe
27. regenerator
28. regenerator packing, 28, 28′, 28″
29. recuperation collector plate
30. recuperation cooler
31. CO₂ cooler collector plate
32. CO₂ cooler
33. CO₂ withdrawal pipe
34. CO₂ cooling and compression plant
35. lean absorbent pipe
36. reboiler pipe
37. reboiler steam pipe
38. lean absorbent flash tank
39. lean absorbent flash gas pipe
40. lean flash gas compressor
41. lean flash liquid withdrawal pipe
42. absorbent make-up system
43. CO₂ cooler pump, 43′ CO₂ cooler
pipe
44. CO₂ cooling water cooler
45. CO₂ cooler water pipe
46. recuperation cooler withdrawal
pipe
47. first cooling water flash tank
48. first flash steam withdrawal pipe
49. first flash steam compressor
50. flashed steam pipe
51. first water withdrawal pipe
52. second cooling water flash tank
53. recuperation cooler water pipe
54. recuperation cooler water pump
55. second flash steam withdrawal
pipe
56. second flash steam compressor
57. recuperation cooler heat
exchanger
58. knock out drum
59. knock out waterpipe
60. lean absoerbent heat exchanger
61. absorbent filter
62. lean exhaust gas knock-out drum
63. condensate pipe
64. Heat exchange coil
65. Heat exchange coil
66. Heat exchange coil
67. Heat exhcanger
68. Heat exchange coil
69. Heat exchange coil
70. duct burner
71. heat exchanger

### DETAILED DESCRIPTION OF THE INVENTION

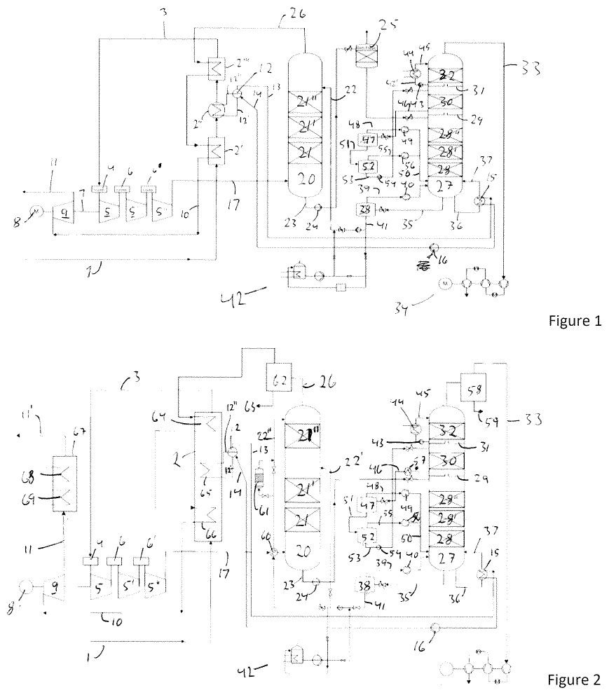

FIG. 1 illustrates a first embodiment according to the present invention. The CO₂ containing gas from which CO₂ is to be captured is typically exhaust gas from a gas turbine, from an industrial process or from combustion of carbonaceous materials as coal, or a plant for waste incineration, is introduced into the plant through an exhaust gas pipe 1. The temperature of the exhaust gas in the exhaust gas pipe is normally from about 350 to 800° C., such as 500 to 600° C., depending on the source for the exhaust gas.

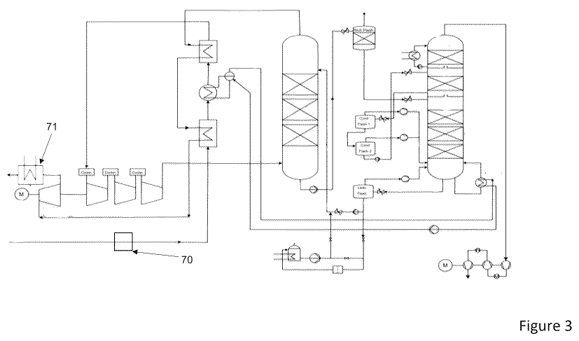

The exhaust gas in exhaust gas pipe 1 is introduced into one or more heat exchangers, to cool the incoming exhaust gas and transferring the heat for heating the outgoing, or lean, exhaust gas as will be described further below, in addition to generating steam for a reboiler as will be described below. FIG. 1 illustrated the use of three heat exchangers 2′, 2″, 2′″ for cooling the incoming exhaust gas but the skilled person will understand that the heat exchangers 2′, 2″, 2′″ might be substituted by one heat exchanger 2, as will be described below with reference to FIG. 2.

Again, with reference to FIG. 1, the incoming exhaust gas is first introduced into a first exhaust gas heat exchanger 2′, wherein the exhaust gas is cooled to a temperature from 250 to 130° C., such as 180 to 150° C. against CO₂ lean exhaust gas as will be described further below. The exhaust gas leaving the first exhaust gas heat exchanger 2′ is then introduced into and further cooled in a reboiler heat exchanger 2″ for generation of steam for a reboiler 15, as will be further described below. After leaving the reboiler cooler 2″, the exhaust gas is introduced into a second exhaust gas heat exchanger 2′ “, where the exhaust gas is further cooled to a temperature of about 100 to 110° C. against compressed CO₂ cleaned flue gas. The reboiler cooler 2” is fed with cooling water through pipe 12′. Heated water and steam leaves the second exhaust gas heat exchanger 2″ through a steam pipe 12″ and is introduced into a steam generator 12, wherein hot water and steam are separated to give steam which is led to a reboiler 15 via a reboiler steam pipe 13, as will be described further below. Condensed steam from the reboiler is pumped by a condensate return pump 16 and returned to the steam generator 12 through a condensate pipe 14. Water collected in the steam generator 12 is returned to the second exhaust gas heat exchanger through the cooling water pipe 12′.

The thus cooled exhaust gas is withdrawn from the second exhaust gas heat exchanger 2′″ through a cooled exhaust gas pipe 3 and introduced into a train of compressors 5, 5′, 5″ for compression of the exhaust gas to a pressure of 6 to 20 bara, such as from 8 to 20 bara, such as 12 to 18 bara, or 15 to 17 bara. The exhaust gas may be further cooled in an exhaust gas cooler 4 before introduction to the compressors. Additionally, intercoolers 6, 6′ are preferably arranged between the compressors 5, 5′, 5″ for cooling the compressed exhaust gas. The train of compressors 5, 5′, 5″ is preferably arranged on a common shaft 7 as a lean exhaust gas expander 9 and a motor/generator 8, as the compressors preferably are driven by the lean exhaust gas expander and possibly the motor/generator 8. The skilled person will understand that the number of compressors 5, 5″, 5″ as shown in the figures are given for illustrative purposes, and that the actual number of compressors may vary dependent on the actual design. The same applies to the intercoolers 6, 6′.

The exhaust gas compressed in the compressors 5, 5′, 5″ is then introduced into the lower part of an absorber 20 via a compressed exhaust gas pipe 17. In the absorber 20 the exhaust gas is brought into countercurrent flow to an aqueous potassium carbonate absorbent over one or more absorber packings 21, 21′, 21″. The absorbent is introduced into the absorber 20 from a lean absorbent pipe 22, to the top of the upper absorber packing 21″ and flows through the packings by gravity and is collected at the bottom of the absorber 20. The skilled person will understand that the number of absorber packings 5,5′, 5″ as shown in the figures are given for illustrative purposes, and that the actual number of packings may vary dependent on the actual design.

The absorbent having absorbed CO₂, or “rich absorbent” as used herein, and which is collected at the bottom of the absorber 20, is withdrawn from the bottom of the absorber 20 through a rich absorbent pipe 23, as will be described below. The exhaust gas leaving the top of the upper absorbent packing 21″ and from which CO₂ has been absorbed and which herein is called “lean exhaust gas”, is withdrawn through lean exhaust gas pipe 26. The lean exhaust gas in the lean exhaust gas pipe 26 is then heated against the heat exchangers 2′″ and 2′ to a temperature of about 360 to 790° C. is withdrawn from the heat exchangers via a reheated lean exhaust gas pipe 10 and introduced into the lean flue gas expander 9 to ambient pressure to give power to drive the compressors 5, 5′, 5″. Normally, the power generated in the lean flue gas expander 9 is sufficient to drive the compressors. Additional power generated in the flue gas expander can be used to produce electrical power in the motor/generator 8. The motor/generator 8 is used as a motor during starting procedures for the plant. The lean exhaust gas leaving the lean exhaust gas expander 9 is then led out into the atmosphere in an outgoing exhaust gas pipe 11, normally through a not shown stack.

The temperatures of the incoming exhaust gas correspond to the typical temperatures from a single cycle gas turbine power plant. In an embodiment the temperature of the incoming exhaust gas may be increased, for example, by duct burning 70, before entering the heat exchangers 2, heating the lean exhaust gas against incoming exhaust gas. Therefore, the increased temperature of the incoming exhaust gas in the heat exchanger 2 provides more energy to the lean exhaust gas. The energy of the expander for expanding of the lean exhaust gas corresponds to the energy needed to compress the incoming exhaust gas in the exhaust gas compressors. At higher temperatures, energy resulting from the expansion exceeds energy used for compression, whereupon the excess energy can be used to generate electrical power by means of an electromechanical generator in order to give electrical power to different consumers in the plant or for export.

The heat exchangers 2′, 2″, 2″ may be combined in one heat exchanger 2 as described below with reference to FIG. 2, wherein heat exchange coils 64, 65, 66 are arranged at different heat levels in the heat exchanger 2 for the required transfer of heat.

The rich absorbent collected at the bottom of absorber 20 is withdrawn through a rich absorbent pipe 23, pumped by means of a rich absorbent pump 24 and introduced into a regenerator 27. An optional rich flash tank 25 may be arranged to the rich absorbent pipe 23 to flash off oxygen which is released into the atmosphere or recirculated to the compressor inlet, before the rich absorbent is introduced into the regenerator 27.

Regenerator packings 28, 28′, 28″ are arranged in the regenerator, below the point where the rich absorbent is introduced into the regenerator 27, and the rich absorbent flows downwards by gravitational force through the regenerator packings 28, 28′, 28″, in countercurrent flow to steam introduced into the regenerator below the regenerator packings to release CO₂ from the rich absorbent. The skilled person will understand that the number of regenerator packings 28, 28′, 28″ as shown in the figures are given for illustrative purposes, and that the actual number of packings may vary dependent on the actual design.

Lean absorbent, i.e., absorbent having released CO₂, is collected at the bottom of the regenerator column, whereas released CO₂ and steam flows upwards in the regenerator column 27 and into a recuperation cooler 30 where the flow of CO₂ and steam is cooled by countercurrent flow to cooling water from a recuperation cooler water pipe 53. Cooling water heated by flow of steam and CO₂ is collected at a recuperation cooler collector plate 29 and withdrawn though recuperation cooler withdrawal pipe 46 and flashed into a first cooling water flash tank 47 to separate steam from water. The steam in the first cooling water flash tank 47 is withdrawn though a first flash steam withdrawal pipe 48, compressed in a first flash steam compressor 49 and introduced as stripping steam into regenerator 27 via a flashed steam pipe 50, below the regenerator packings 28, 28′, 28″. The water phase from the first cooling water flash tank 47 is withdrawn through a first flash water withdrawal pipe 51 and is flashed into a second cooling water flash tank 52 to separate water from steam. Steam in flash tank 52 is withdrawn through a second flash steam withdrawal pipe 55, compressed in a second flash steam compressor 56, and combined with the flash steam from the first cooling water flash tank 47 in the flashed steam pipe 50. Water collected in the second cooling water flash tank 52 is withdrawn though the recuperation cooler water pipe 53, pumped by means of a recuperation cooling water pump and introduced into the top of the recuperation cooler 30 as described above.

CO₂ and steam leaving the recuperation cooler enters into a CO₂ cooler 32 for further cooling, via a CO₂ cooler collector plate 31, and is cooled by countercurrent cooling to cooling water introduced from a CO₂ cooler water pipe 45. Cooling water is collected at the CO₂ cooler collector plate 31, withdrawn through a CO₂ cooler recycle pipe 43′, and pumped by a CO₂ cooler pump 43 via a CO₂ cooling water cooler 44 and into the CO₂ cooler 32 via the CO₂ cooler water pipe 45. The gaseous phase of steam and CO₂ at the top of the regenerator 27 is withdrawn though a CO₂ withdrawal pipe 33 and is further treated by drying and compression in a CO₂ cooling and compression plant 34 to give substantially pure CO₂ for safe deposition or storage thereof.

Lean, or regenerated absorbent, is collected at the bottom of the regenerator 27, and is withdrawn through a lean absorbent pipe 35. The lean absorbent is preferably introduced into a lean absorbent flash tank 38 and separated into a gas phase and a liquid phase. The gas phase is withdrawn though a lean flash gas pipe 39, compressed in a lean flash gas compressor 40, and introduced into the regenerator 27 below the regenerator packings 28, 28′, 28″ as additional stripping steam. The liquid phase is withdrawn though a lean flash liquid withdrawal pipe 41 and is pumped by a lean absorbent pump though the lean absorbent pipe 22 and introduced into the absorber 20 as described above. An absorbent make-up system 42, is preferably arranged to pipe 41, 22 for removal of excessive volumes of absorbent, or for addition of more absorbent, according to the need thereof.

The amount of steam for regeneration of the absorbent in the regenerator 27 generated as described above by flashing, is not sufficient and additional steam has to be added. A part of the lean absorbent at the bottom of the regenerator 27, is withdrawn through a reboiler pipe 36 and introduced into the boiler 15, wherein the lean absorbent is heated to generate steam against steam introduced from the reboiler steam pipe 13. Steam generated in the reboiler is introduced as stripping steam into the regenerator 27 below the regenerator packings via a reboiler stripper steam pipe 37. Cooled steam from the reboiler steam pipe 13, is withdrawn through the condensate pipe 14, via a pump 16.

FIG. 2 is based on FIG. 1, but includes different features not described in the basic configuration of FIG. 1. The skilled person will understand that the additional features illustrated in FIG. 1, and which are dependent on each other, may be included individually in the basic configuration of FIG. 1. Elements present in both FIGS. 1 and 2 will only be referred to in the description of FIG. 2 in the extent it is necessary for the description.

FIG. 2 illustrates an embodiment where the heat exchangers 2′, 2″, 2′″ are substituted by one single multistep heat exchanger 2, having heat exchanging coil 64, 65, 66 at different levels of the heat exchanger 2. It is well known to the skilled person to do such substitution, and in practice, one combined heat exchanger is often illustrated as separate units.

An optional lean exhaust pipe knock-out drum 62 may be arranged to the lean exhaust gas pipe 26, to separate and remove condensed water from the lean exhaust gas via a condensate pipe 63, before the lean exhaust gas is introduced into the heat exchanger(s) 2, 2′, 2″, 2′″.

The lean exhaust gas leaving the lean flue gas expander 9 may still be relatively hot. Provided that the temperature of the expanded lean flue gas is higher than 120° C., it may be beneficial to further cool the flue gas in a lean expanded flue gas heat exchanger 67, against cooling water for generation of steam in a reboiler heat exchange coil 69, and/or in a recuperation heater heat exchange coil 68, before the lean exhaust gas is released through a cooled lean exhaust gas pipe 11′. The steam generated in the reboiler steam exchange coil 69 is led to the reboiler 15 for heating of the lean absorbent therein, and the thus cooled and condensed water is returned to the reboiler heat exchange coil 69, to reduce the requirement for steam from the steam generator 12. Steam generated in the recuperation cooler heat exchange coil 68 is led to a recuperation cooler heat exchanger 57 for further heating of the cooling water from the recuperation cooler in pipe 46 for generation of more steam in the flash tanks 47, 52.

A CO₂ knock out drum 58 may be arranged in the CO₂ withdrawal pipe 33 for removal of condensed water in the flow of steam and CO₂, and thus to reduce the amount of water entering the CO₂ plant 34. The water collected in the knock out drum is withdrawn via a knock out water pipe 59.

FIG. 2 also illustrates an alternative design of the absorber 20, and the flow of absorbent into the absorber. The flow of lean aborbent from the withdrawn from the lean absorbent pipe 35 is split in two flows, optionally after being flashed over the a lean absorbent flash tank 38 as described above, into a first lean absorbent pipe 22′ and a second lean absorbent pipe 22″. The lean absorbent in the first lean absorbent pipe 22′ is introduced into the absorber 20 at the top of one of one of the intermediate packings, such as at the top of the second absorber packing, i.e., 21′ of three packings 21, 21′, 21″, to flow countercurrent to the incoming CO₂ rich gas in the packing(s) below. The lean absorbent in the second lean absorbent pipe 22″ is cooled by a lean absorbent heat exchanger 60 against the compressed CO₂ rich gas in the compressed exhaust gas pipe 17 having a temperature of typically about 60° C. and introduced to the top of the uppermost absorbent packing 21″. Splitting the lean absorbent into two flows as described and introducing cooled lean absorbent at the top of the uppermost absorbent packing 21″ may increase the total absorption of CO₂ in the absorber. The concentration of CO₂ in the gas flowing upwards in the absorber is reduced by absorption of CO₂ of the absorbent flowing countercurrent to the gas. However, absorption is an exothermic process causing the temperature to increase as the gas flows upwards. Introducing lean and cooled absorbent at the top of the uppermost absorbent packing cools the gas and allows for more efficient absorption in the uppermost absorber packing.

An optional absorbent filter 61 may be arranged to remove particles from the lean absorbent. The skilled person will understand that the optional lean absorbent filter 61 may be arranged in alternative positions in the flow of the lean absorbent.

The skilled person will understand that the splitting of the lean absorbent as described with reference to FIG. 2 may also be applied to the embodiment of FIG. 2.

1. A method for capturing CO2 from a CO2 rich gas,
where CO2 is absorbed from the CO2 rich gas to give a CO2 lean gas and CO2 rich absorbent, where the CO2 rich absorbent is withdrawn and introduced into a regenerator where absorbent is stripped to give a regenerated, or lean, absorbent which is recycled to an absorber, and CO2, which is treated further,
where the lean exhaust gas is reheated in heat exchangers (2, 2′, 2″, 2′″) and expanded over an expander to give power for driving the compressors (5, 5′, 5″), and
where a part of the heat from the cooling of the incoming CO2 rich gas in the heat exchangers (2, 2′, 2″, 2″) is used for generating steam for regeneration of the rich absorbent,
wherein the method comprises receiving the CO2 rich gas at near atmospheric pressure and at a temperature of 350 to 900° C., cooling the incoming exhaust gas in exhaust gas heat exchangers (2, 2′, 2″, 2″) and compressing the exhaust gas in compressors (5, 5′, 5″) before introducing the exhaust gas into the absorber.

2. The method of claim 1, where the temperature of the incoming exhaust gas is increased, before entering the heat exchangers.

3. The method of claim 2, where the temperature of the incoming exhaust gas is increased by duct burning.

4. The method of claim 1, where the lean exhaust gas expanded over expander is entering a heat exchanger.

5. The method of claim 4, where the lean exhaust gas is heating the incoming exhaust gas in heat exchanger.

6. A plant for capturing CO2 from an incoming CO2 rich gas, comprising:
an incoming exhaust gas pipe for receiving incoming exhaust gas, one or more exhaust gas heat exchanger(s) (2, 2′, 2″, 2″) for cooling of the incoming exhaust gas,
one or more compressor(s) (5, 5′, 5″) for compression of the cooled exhaust gas,
an absorber for absorption of CO2 from the incoming exhaust gas against an aqueous potassium carbonate absorbent,
a lean exhaust gas pipe (26) for introduction of the lean exhaust gas into the exhaust gas heat exchangers (2, 2′, 2″, 2′″) for heating of the lean exhaust gas against incoming exhaust gas,
an expander for expanding the lean exhaust gas before releasing the lean exhaust gas into the atmosphere, where the expander is arranged to drive the compressor(s) (5, 5′, 5″),
a rich absorbent pipe for withdrawing the rich absorbent from the absorbent and introducing the rich absorbent into a regenerator for regenerating the absorbent to give lean absorbent,
a lean absorbent pipe for returning regenerated, or lean, absorbent into the absorber,
a steam generator is connected to one of the exhaust gas heat exchangers (2″) or a heat coil via a steam pipe (12′) and a cooling water return pipe (12″) to generate steam,
a reboiler steam pipe is arranged to deliver the generated steam into a reboiler for heating lean absorbent to generate steam for regeneration of the absorbent in the regenerator, and
a condensate return pipe for returning water condensed during heating of the lean absorbent in the reboiler back to the steam generator,
wherein the heat exchanger(s) (2, 2′, 2″, 2″) for cooling of the incoming exhaust gas are arranged upstream the one or more compressor(s) (5, 5′, 5″) for compression of the cooled exhaust gas.

7. The plant of claim 6, comprising a heater upstream the heat exchanger(s).

8. The plant of claim 7, where the heater is a duct burner.

9. The plant of claim 6, comprising a heat exchanger downstream the expander.
